(19) United States
(12) Patent Application Publication
(10) Pub. No.: US 2015/0331698 A1
(43) Pub. Date: Nov. 19, 2015

(54) METHOD FOR LOADING AN APPLICATION CONSISTING OF A PLURALITY OF COMPONENTS INTO A DEVICE CONSISTING OF A PLURALITY OF COMPONENTS

(71) Applicant: GIESECKE & DEVRIENT GMBH, Munich (DE)

(72) Inventors: Claus DIETZE, Obersochering (DE); Gero GALKA, Valley (DE)

(21) Appl. No.: 14/758,464

(22) PCT Filed: Dec. 16, 2013
(86) PCT No.: PCT/EP2013/003803

§ 371 Date: Jun. 29, 2015

(30) Foreign Application Priority Data
Jan. 3, 2013 (DE) 102013000106.4

(51) Int. Cl. G06F 9/445; G06F 9/44

(52) U.S. Cl. CPC G06F 9/44505; G06F 9/4406

(57) ABSTRACT

The invention provides a method for loading an application unit into a device, with the device comprising a plurality of device components, and the application unit comprising two or more application components, and one application component being intended for one device component in each case. The application unit is loaded into a selected device component of the device components. Starting out from the selected device component, each application component is loaded into that device component for which the application component is intended.

This invention relates to a method for loading an application unit into a device, with the device comprising a plurality of device components, and the application unit comprising two or more application components, with one application component being intended for one device component in each case.

Devices such as mobile stations comprise a plurality of device components. A mobile station comprises a mobile end device, e.g. mobile telephone or smartphone, and a secure element or Secure Element, e.g. SIM/USIM card, UICC or embedded UICC (eUICC). Some applications of a mobile station run while being distributed over the device components. Additionally, some mobile end devices have a bipartite runtime architecture (sometimes also called an ARM architecture, after a provider of such an architecture), which comprises a normal execution (runtime) environment under a common normal operating system and additionally a trusted or secure execution environment under a security operating system. Here, the mobile station thus already comprises three separate device components, namely, the secure element, the normal execution environment and the trusted execution environment.

For the distributed application to be functional, it is necessary that the application components of the individual device components are mutually matched and complete.

When a distributed application comprising a plurality of application components for a plurality of device components of the mobile station is newly loaded into the mobile station, each application component must be loaded into the right device component. When a distributed application already available in the mobile station is changed, e.g. updated or personalized, by change data, the change data (e.g. updating or personalization data) must be fed to the right, already available application components.

Conventionally, the application components of distributed applications or change data for distributed applications are loaded into the device components individually via the over-the-air (OTA) interface through different servers, as shown by way of example in FIG. 2. To load applications or changes for applications into a trusted execution environment OTA, there is employed for example a Trusted Service Manager TSM. To load applications or changes therefore into a normal execution environment, there is employed for example an OTA server. To load applications or changes therefore into a secure element (e.g. SIM card, etc.) of a device, there is employed for example a SIM OTA server.

Due to the loading through a plurality of independent servers, there is the danger of application components that belong together being wrongly loaded into device components of different devices. This can result in the distributed application being altogether incomplete, because application components are lacking, or inconsistent, because wrong application components have been received. In each of these two cases the distributed function is normally non-functional.

The invention is based on the object of providing a method that enables an application distributed over a plurality of components of a device, or changes (e.g. updates or personalization data) for a distributed application, to be loaded into the device reliably, completely and consistently.

This object is achieved by a method according to claim 1.

The method according to claim 1 is provided for loading an application unit into a device which comprises a plurality of device components. The application unit comprises two or more application components, with one application component being intended for one device component in each case. The application unit comprises application components for all or some (at least two) device components of the device. The method is characterized in that the application unit, comprising the application components, is loaded into a selected device component of the device components and, starting out from the selected device component, each application component is loaded into that device component for which the application component is intended.

The application unit is thus first loaded as a whole into the device. The application component of the selected device component is already loaded into the right device component. The one or more other application components are loaded into the right one or more other device components from the selected device component. This ensures that all required application components are loaded into one and the same device.

An incomplete loading of a distributed application is avoided. On the other hand, it is ensured that all loaded application components belong to the same higher application unit. It is thus avoided that a distributed application is loaded inconsistently (application components are loaded that do not belong to the same device). Only in the device itself are the application components for the individual device components mutually separated and distributed.

Hence, according to claim 1 there is provided a method that enables an application distributed over a plurality of components of a device, or changes for a distributed application, to be loaded into the device reliably, completely and consistently.

Electively, there is provided as a device a mobile station which comprises a mobile end device and a secure element operable in the end device, there being provided as device components at least the secure element and the mobile end device.

Electively, there are implemented in the mobile end device a normal execution environment under the management of a normal operating system, and a trusted execution environment under the management of a security operating system, and there being provided as the device component that is formed by the end device at least the normal execution environment and the trusted execution environment. Altogether, the device thus comprises the three device components, secure element, normal execution environment and trusted execution environment.

Electively, there is provided as a selected device component a device component having a high security level, e.g. the secure element or the trusted execution environment. This causes the division of the application unit into application components to be carried out in a secure environment, under the management of a security instance. Application components that are intended for a device component having a high security level are always treated in an environment having a high security level. The division of the application unit in an insecure device component (e.g. in the normal execution environment) could, in contrast, offer possibilities for attacking application components for secure device components (e.g. secure element or trusted execution environment).

According to one embodiment, an application unit for an end device having a secure element is first loaded as a whole into the secure element. The application unit comprises an application component for the end device and an application component for the secure element. The application component for the secure element is already in the right device component. The application component for the end device is extracted from the application unit and loaded into the end device from the secure element.

According to further embodiments, an application unit for an end device having a normal execution environment, a trusted execution environment and a secure element is first loaded as a whole into the trusted execution environment (alternatively into the secure element). The application unit comprises one application component for the normal execution environment, the trusted execution environment and the secure element in each case. The application component for the trusted execution environment (alternatively for the secure element) is already in the right device component. The application components for the secure element and for the normal execution environment (alternatively for the trusted execution environment and the normal execution environment) are extracted from the application unit and loaded into the secure element or the normal execution environment (alternatively into the trusted execution environment or the normal execution environment) from the trusted execution environment (alternatively from the secure element).

Electively, there is provided as an application unit an application to be newly loaded into the device. The application is loaded into the device, divided into application components in the device (in the selected device component), and each application component is implemented in the appurtenant device component.

Electively, there is provided as an application unit an application change for an application already available in the device.

Electively, there are provided as an application change updating data for updating the available application and/or personalization data for personalizing the available application.

Electively, after the loading of the application change the available application is changed, e.g. updated or personalized, according to the application change. In so doing, the already available application components to be changed by the application changes are changed with the loaded application components containing the application changes. The operation of updating or personalizing the individual components of the already available application (i.e. of the already available application components) with the newly loaded data (with the newly loaded application components by which the changes are formed) per se can be effected in an arbitrary known manner.

Electively, there is additionally carried out in the method a functionality test, wherein:

the loaded application components, or the available application components changed with the loaded application components, are put into operation,

it is checked whether the application components work together as intended, so that the total, possibly changed, application unit is put into operation, and

if the application components work together as intended, the loading of the application unit is defined as terminated, and

if the application components do not work together as intended, an error handling measure is taken.

As an error handling measure there can be provided for example another loading of the application unit. Alternatively or additionally, another implementing of a newly loaded application can be provided, or another updating or personalizing of an already available application with the newly loaded change data (e.g. updating data or personalization data), or both.

Hereinafter the invention will be explained more closely on the basis of exemplary embodiments and with reference to the drawing, in which there are shown:

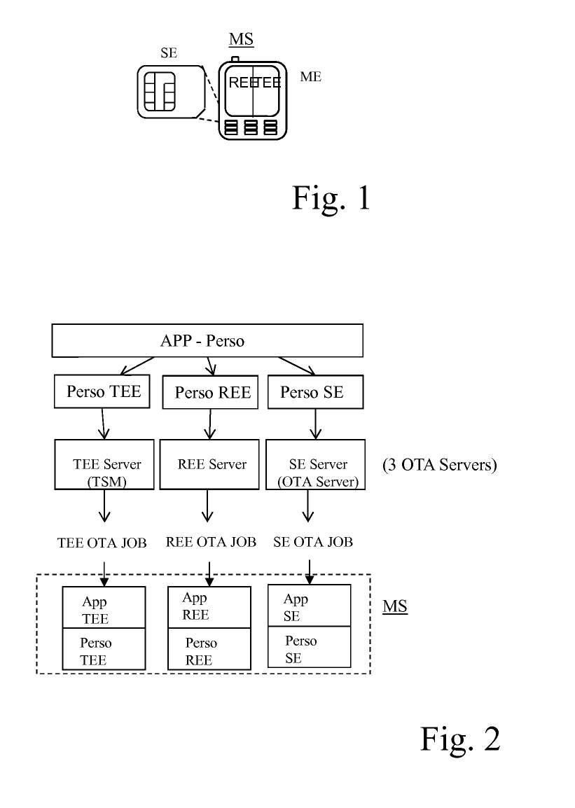

FIG. 1 a schematic representation of a mobile station which comprises an end device having a normal execution environment and a trusted execution environment, and a secure element;

FIG. 2 a schematic flowchart for the conventional loading of personalization data for a distributed application into the mobile station from FIG. 1;

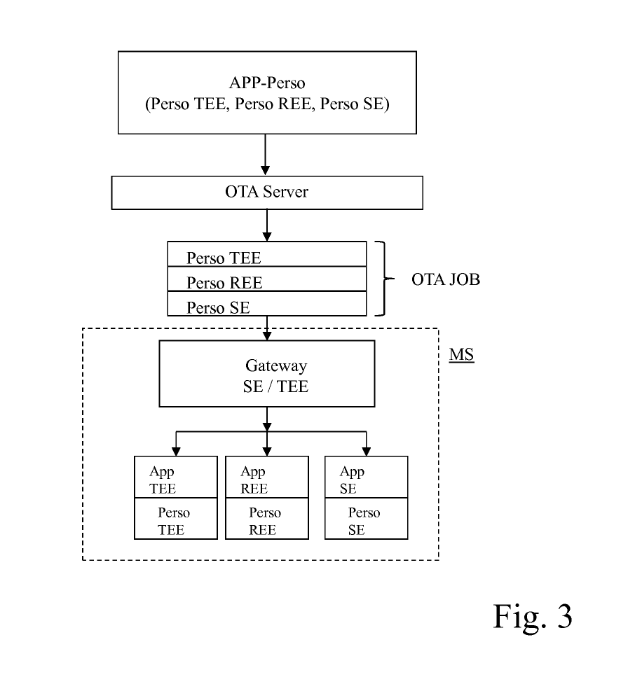

FIG. 3 a schematic flowchart for the loading of personalization data for a distributed application into the mobile station from FIG. 1, according to an embodiment of the invention;

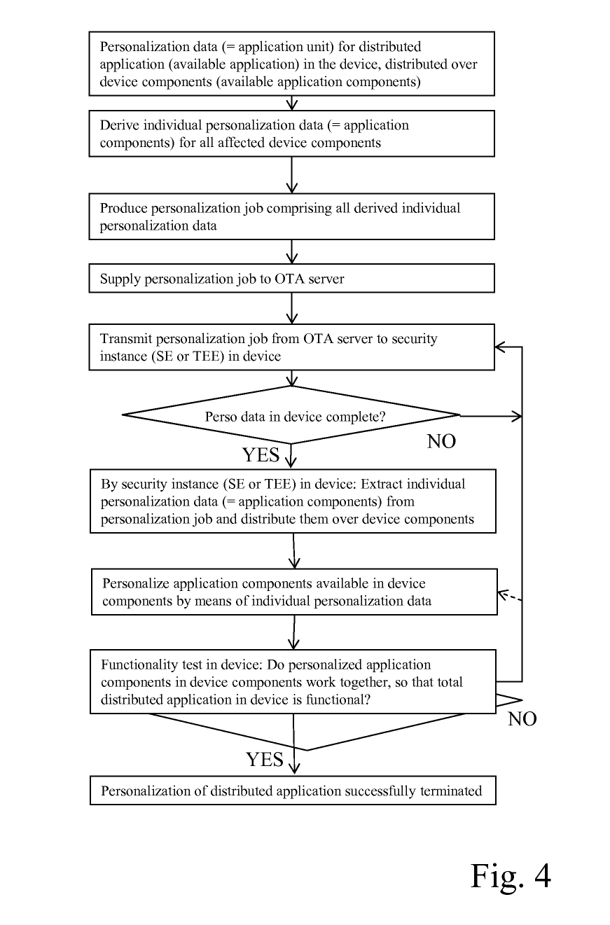

FIG. 4 a flowchart for the overall sequence of the personalization of a distributed application in the mobile station from FIG. 1, according to an embodiment of the invention.

FIG. 1 shows a schematic representation of a typical mobile station MS which comprises an end device (mobile entity) ME having a normal execution environment REE (Rich Execution Environment) and a trusted execution environment TEE (Trusted Execution Environment), and a secure element SE. The secure element SE is designed as a removable SIM/USIM card, and can alternatively be hard-implemented, e.g. as an eUICC. The normal execution environment REE is controlled by an arbitrary normal operating system usual for mobile telephones and smartphones. The trusted execution environment TEE is controlled by a security operating system. Applications are implemented in the normal execution environment REE and in the trusted execution environment TEE. In the secure element SE applications are implemented in the form of applets. Some applications are implemented so as to be distributed over the mobile station MS, so that one application component of the application is implemented in the secure element SE, in the normal execution environment REE and in the trusted execution environment TEE in each case. When the distributed application is in operation, the application components in the secure element SE, in the normal execution environment REE and in the trusted execution environment TEE work together, so that altogether the distributed application runs and functions. If the distributed application must be changed, e.g. updated or personalized, the application components affected by the changes must be changed equally in the secure element SE, in the normal execution environment REE and in the trusted execution environment TEE.

FIG. 2 shows a schematic flowchart for the conventional loading of personalization data for a distributed application APP into the mobile station MS from FIG. 1. The application APP is distributed over trusted execution environment TEE, normal execution environment REE and secure element SE, and comprises a component APP TEE in the trusted execution environment TEE, a component APP REE in the normal execution environment REE and a component APP SE in the secure element SE. On a content server, personalization data APP-Perso are produced for the distributed application APP and divided into individual personalization data Perso TEE, Perso REE and Perso SE for the device components TEE, REE and SE, respectively. Each of the sets of individual personalization data Perso TEE, Perso REE and Perso SE is transmitted to a separate OTA server, TEE server TSM, REE server or SE OTA server, which is arranged for data maintenance of the respective device component TEE, REE and SE. The TEE TSM server produces from the personalization data for the TEE, Perso TEE, a transmittable data packet receivable by the mobile station MS, a so-called OTA job, more precisely, a TEE OTA job receivable by the trusted execution environment, and transmits the TEE OTA job to a trusted execution environment TEE managed by the TEE TSM. The REE server analogously produces from the personalization data Perso REE a REE OTA job and transmits it to a normal execution environment REE managed by the REE server. The SE OTA server produces in an analogous manner from the personalization data Perso SE a SE OTA job (data packet receivable by SE) and transmits it to a secure element SE managed by the SE OTA server. If all three OTA servers transmit their OTA jobs, and thus the individual personalization data, to the same mobile station MS, the basic requirements for a successful personalization of the application APP are created.

FIG. 3 shows a schematic flowchart for the loading of personalization data APP-Perso for a distributed application APP into the mobile station MS from FIG. 1, according to an embodiment of the invention. At a content server, personalization data APP-Perso are produced for the distributed application APP and supplied to a central OTA server. Personalization data APP-Perso comprise individual personalization data Perso TEE, Perso REE and Perso SE for the trusted execution environment TEE, the normal execution environment REE and the secure element SE. The OTA server produces from the bundled personalization data APP-Perso (comprising Perso TEE, Perso REE, Perso SE) a single OTA job and transmits it to the mobile station MS. The OTA job is matched with that device component that is selected for receiving and dividing the OTA job, for example the secure element SE or the trusted execution environment TEE. The selected device component acts in the mobile station MS as a gateway, i.e. as a distribution station, for the personalization data APP-Perso. The gateway divides the personalization data APP-Perso into individual personalization data and relays the individual personalization data Perso TEE, Perso REE and Perso SE to the device components, trusted execution environment TEE, normal run time environment REE and secure element SE, respectively. The further personalization of the application components APP TEE, APP REE and APP SE with the individual personalization data Perso TEE, Perso REE and Perso SE is carried out for example in the conventional manner.

A comparison of the personalization according to the invention according to FIG. 3 with the conventional personalization from FIG. 2 shows that in the personalization according to the invention only a single OTA server is required. Conventionally, in contrast, as many servers OTA are required as the mobile station has device components (thus three OTA servers in FIG. 2).

According to FIG. 3, the personalization data are transmitted in a single OTA job. If it is expedient, the single OTA server can also transmit a plurality of OTA jobs (successively).

FIG. 4 shows a flowchart for the overall sequence of the personalization of a distributed application APP in the mobile station MS from FIG. 1, according to an embodiment of the invention. From personalization data APP-Perso for a distributed application APP, individual personalization data Perso TEE, Perso REE, Perso SE for all affected device components TEE, REE, SE are derived and joined into a single personalization OTA job. The OTA job is transmitted to the mobile station MS, more precisely, to a device component having a high security level and having the function of a security instance in the mobile station MS, for example the secure element SE or the trusted execution environment TEE. The security instance (SE or TEE) checks whether the OTA job has been received completely. If “no”, the security instance requests the server OTA to retransmit the OTA job. If “yes”, the security instance extracts from the personalization OTA job the individual personalization data Perso TEE, Perso REE, Perso SE and distributes them over the device components TEE, REE, SE of the mobile station MS. The application components APP TEE, APP REE, APP SE are personalized with the individual personalization data Perso TEE, Perso REE, Perso SE. Subsequently, a functionality test is carried out by the security instance/gateway to verify that the personalized application components still work together after personalization. If “yes”, the personalization of the distributed application is successfully terminated. If “no”, the personalization is repeated, or the loading of the personalization data is repeated, and thereafter the personalization.

In FIGS. 2-4 the personalization of a distributed application APP available in the mobile station MS was set forth. In an analogous manner, other changes of an available distributed application are carried out, e.g. updates of an available distributed application, as well as the new loading of an as yet unavailable distributed application into the mobile station MS.

1-9. (canceled)

10. A method for loading an application unit into a device, with the device comprising a plurality of device components, and the application unit comprising two or more application components, and with one application component being intended for one device component in each case,
wherein
the application unit, comprising the application components, is loaded into a selected device component of the device components and, starting out from the selected device component, each application component is loaded into that device component for which the application component is intended.

11. The method according to claim 10, wherein there is provided as a device a mobile station which comprises a mobile end device and a secure element operable in the end device, and wherein there is provided as device components at least the secure element and the mobile end device.

12. The method according to claim 11, wherein there are implemented in the mobile end device a normal execution environment under the management of a normal operating system and a trusted execution environment under the management of a security operating system, and wherein there are provided as the device component that is formed by the end device at least two device components, namely, the normal execution environment and the trusted execution environment.

13. The method according to claim 12, wherein there is provided as a selected device component a device component having a high security level including a secure element or the trusted execution environment (TEE).

14. The method according to claim 10, wherein there is provided as an application unit an application to be newly loaded into the device, comprising two or more application components.

15. The method according to claim 10, wherein there is provided as an application unit an application change for an application already available in the device.

16. The method according to claim 15, wherein there are provided as an application change updating data for updating the available application and/or personalization data for personalizing the available application, the application change comprising two or more application components.

17. The method according to claim 15, wherein after the loading of the application change the available application is changed according to the application change.

18. The method according to claim 10, wherein a functionality test is additionally carried out, wherein in the functionality test:
the loaded application components, or the available application components changed with the loaded application components, are put into operation,
it is checked whether the application components put into operation work together as intended, so that the total, possibly changed, application is put into operation, and
if the application components put into operation work together as intended, the loading of the application unit is defined as terminated, and
if the application components put into operation do not work together as intended, an error handling measure is taken.
